(19) United States
(12) Patent Application Publication
(10) Pub. No.: US 2024/0379024 A1
(43) Pub. Date: Nov. 14, 2024

(54) METHOD AND SYSTEM FOR VIRTUAL REALITY GUIDED IMAGERY ACUPUNCTURE

(71) Applicant: Jian KONG, Malden, MA (US)

(72) Inventor: Jian KONG, Malden, MA (US)

(21) Appl. No.: 18/659,449

(22) Filed: May 9, 2024

Related U.S. Application Data
(60) Provisional application No. 63/500,945, filed on May 9, 2023.

(51) Int. Cl. G09B 19/00; G02B 27/01; G06F 3/01; G06T 13/40

(52) U.S. Cl. CPC G09B 19/00; G02B 27/017; G06F 3/011; G06T 13/40

(57) ABSTRACT

A method for treating a patient with a virtual reality (VR) guided acupuncture includes: determining a prescription of acupuncture points or specific body locations; and showing the patient the prescribed acupuncture points or specific body locations being activated on an avatar in a virtual reality viewing device.

### CROSS-REFERENCE TO RELATED APPLICATION

This application claims priority to U.S. Provisional Patent Application No. 63/500,945, filed on May 9, 2023, and the entire content of which is incorporated herein by reference.

### TECHNICAL FIELD

The present disclosure relates to the technical field of virtual reality technology, and more particularly, to a method and a system for treating a patient with virtual reality guided acupuncture.

### BACKGROUND

The use of imagery to treat illness is one of the oldest medical practices. Research findings support the notion that the brain responds to imagined experience similarly to the way it responds to actual experience. Therefore, the functional aspects of mental imagery could be underpinned by common neurocognitive processes that facilitate both imagination and perception.

Virtual reality (VR) technology has found extensive applications across diverse sectors. The technology can greatly enhance imagery processing. Thus, the application seeks to integrate VR technology with the imagery of acupuncture and other body stimulation methods to generate a therapeutic effect when actual treatments or stimuli are unavailable, and to amplify the effectiveness and experience of these therapies when used by itself or alongside actual treatments, through the visualization of treatment.

Although the current market offers many VR systems designed to alleviate various symptoms, none combine VR with imagery and acupuncture/body stimulation to address specific symptoms. Such a system could be used in conjunction with other treatments or independently in home or clinical settings to treat chronic pain and other disorders.

### SUMMARY

One aspect of the present disclosure provides a method for treating a patient with a virtual reality (VR) guided acupuncture. The method includes: determining a prescription of acupuncture points or specific body locations based on various medicine theories; and showing the patient the prescribed acupuncture points or specific body locations being activated on an avatar in a virtual reality viewing device.

Another aspect of the present disclosure provides a system for treating a patient with a virtual reality (VR) guided acupuncture. The system includes: a processor; a memory storing an application program; a user interface; a communication interface; a VR recording device; and a VR headset. When being executed by the processor, the application program causes the processor to: determine a prescription of acupuncture points or specific body locations; and show the patient the prescribed acupuncture points or specific body locations being activated on an avatar in the VR headset.

Another aspect of the present disclosure provides a system for treating a patient with a virtual reality (VR) guided acupuncture. The system includes: a processor; a memory storing an application program; a user interface; a communication interface; a VR recording device; a VR headset; and a plurality of actuators capable of being attached to the patient and controlled by the application program to simulate acupuncture needles. When being executed by the processor, the application program causes the processor to: determine a prescription of acupuncture points or specific body locations; and show the patient the prescribed acupuncture points or specific body locations being activated on an avatar in the VR headset.

### BRIEF DESCRIPTION OF THE DRAWINGS

FIG. 1 is a flowchart of a method for treating a patient with virtual reality guided acupuncture according to some embodiments of the present disclosure;

FIG. 2 is a flowchart of a process of obtaining content for treating a patient with virtual reality guided acupuncture according to some embodiments of the present disclosure;

FIG. 3 is a schematic diagram showing a patient watching treatment content through a VR headset according to some embodiments of the present disclosure;

FIG. 4 is a schematic diagram showing a patient's hand interacting with a virtual needle according to some embodiments of the present disclosure; and

FIG. 5 is a structural diagram of a system for treating a patient with virtual reality guided acupuncture according to some embodiments of the present disclosure.

### DETAILED DESCRIPTION OF THE EMBODIMENTS

To make the objectives, technical solutions, and advantages of the present disclosure clearer, the technical solutions in the embodiments of the present disclosure will be clearly and completely described below in conjunction with the accompanying drawings in the embodiments of the present disclosure. Obviously, the embodiments described herein are merely some of the embodiments of the present disclosure, but not all of them. Based on the embodiments in the present disclosure, all other embodiments obtained by those of ordinary skill in the art without creative efforts should fall within the scope of protection of the present disclosure. Under the circumstances of no conflict, the embodiments and features in the present disclosure may be combined with each other arbitrarily. The processes illustrated in the flowcharts of the drawings may be a set of computer-executable instructions performed in a computer system. Although a logical order is shown in the flowcharts, in some cases the processes shown or described may be performed in an order different from described herein.

Visualization of others experiencing pain can activate networks similar to those activated when one directly experiences pain. Additionally, subjects imagining painful scenarios involving themselves may experience more painful and vivid imagery than scenarios involving other individuals and produce stronger brain activation. Showing subjects a video clip of themselves undergoing acupuncture, coupled with imagining the acupuncture stimulation, can lead to wide spreading brain activation and deactivation.

Guided imagery of acupuncture through video can invoke effect in patients that are similar to actual acupuncture stimulation in subjects, enhance deactivation of a crucial brain area within the default mode network (anterior cingulate cortex), a network often disrupted in chronic low back pain and disorders like depression, and increase the pressure threshold (an indicator of analgesia) compared to a control condition in human subjects. Therefore, visualizing acupoint, or tender point or ashi point stimulation through methods like acupuncture, electrical stimulation, touching, and massage also lead to changes in brain activity that could alleviate symptoms.

Low back pain (LBP) is a prevalent reason for medical consultations in the United States. Many patients with chronic LBP (cLBP) find that current treatment methods fall short of their needs. This underscores the critical need for the development of innovative treatments for CLBP.

Historically, the application of imagery in medical treatments, especially for chronic pain, is a well-established practice. Recent studies indicate that the brain processes imagined experiences in ways similar to real experiences. Acupuncture, a time-honored invasive therapy, has received endorsement from the American College of Physicians as a treatment for cLBP recently. Research has demonstrated that both real and visualized acupuncture needle stimulation activate similar areas of the brain, hinting that imagery-based acupuncture might mimic the therapeutic effects of the actual procedure through similar neurological pathways.

A new therapeutic approach called 2-dimensional video-guided acupuncture imagery treatment (2D-VGAIT) has been introduced by integrating acupuncture with mental imagery techniques. Clinical trials indicate that 2D-VGAIT not only has an analgesic effect in healthy individuals but also provides symptom relief comparable to actual acupuncture in cLBP patients over a one-month period, encompassing six treatment sessions. Further, the limitation of 2D videos in fully replicating the sensory experience can be improved by applications of virtual reality (VR) technologies. VR has been shown to be effective in studying body perception and inducing body-ownership illusions. Embodiments of the present disclosure therefore apply VR technologies to further enhance the effectiveness of 2D-VGAIT.

There is accumulating evidence suggesting that the brain processes imagined experiences similarly to real ones. This indicates that the same neurocognitive functions may support both imagination and actual perception. For instance, visualizing another person in pain can trigger the same neural networks as experiencing pain oneself. Likewise, when individuals imagine themselves in painful situations, they tend to experience more intense and vivid sensations, resulting in greater activation of pain-related areas in the brain.

Acupuncture, a procedure involving the insertion and manipulation of needles, typically induces sensations like aching and tingling, known as deqi, which are essential for its pain-relieving effects. Studies, including brain imaging, have shown that visualizing acupuncture needle stimulation activates similar brain areas involved in actual acupuncture, such as the anterior insula and the middle/anterior cingulate cortex.

In a 2D-VGAIT treatment, participants watch a 2D video of acupuncture that was previously administered to them, while simultaneously imagining the acupuncture being applied. 2D-VGAIT has been found to evoke deqi sensations and produce an analgesic effect without actual needle insertion. The 2D-VGAIT treatment also affects brain activity in crucial regions like the anterior insula and anterior cingulate cortex, which are involved in pain perception and modulation. Further, the 2D-VGAIT treatment can alter the functional connectivity of the periaqueductal grey, an important part of the pain modulation system. In some studies, 2D-VGAIT demonstrated comparable symptom relief to traditional acupuncture in cLBP patients after multiple sessions of treatments.

However, 2D-VGAIT has limitations in terms of the sense of presence and the vividness of the imagery it creates. Virtual reality (VR), by offering an immersive 3-dimensional environment, overcomes these limitations by providing a more realistic and engaging experience. This not only enhances treatment adherence but also improves effectiveness and potential for commercialization.

In embodiments consistent with the present disclosure, a novel mind-body treatment called VR video-guided acupuncture imagery treatment (VRGAIT) has been developed to combine VR, imagery, and acupuncture to enrich the immersive quality and effectiveness of the existing 2D-VGAIT for alleviating cLBP.

The VRGAIT for cLBP patients reduces dependence on opioid medications and holds significant clinical promise. cLBP ranks as the fifth leading cause for physician visits in the USA and incurs annual costs of around $200 billion. It is also the foremost cause of years lived with disability (YLDs), accounting for 10.7% of total YLDs. The prevalence of cLBP is expected to rise, especially in low-income and middle-income countries. The most prevalent form of cLBP is non-specific LBP, affecting individuals across all age groups.

Despite debates over their efficacy, opioids remain the most frequently prescribed medications for managing cLBP. Opioid prescription rates have surged in the USA, positioning opioid analgesics as an almost “indispensable” tool for chronic pain management. However, this increase in use has been accompanied by a rise in opioid addiction, abuse, and fatal overdoses. Meanwhile, the development of new non-opioid, non-addictive pain medications has been limited in recent years. Therefore, there is an urgent need for innovative treatments for cLBP.

Experts have suggested adopting a biopsychosocial approach to managing cLBP, prioritizing non-pharmacological treatments and cautious use of medications, imaging, and surgery. Recent recommendations have advocated for embracing the concept of positive health, the capacity to adapt and self-manage amidst social, physical, and emotional challenges, in treating cLBP. This approach emphasizes coping with long-term LBP through self-management techniques, supported by findings that active strategies like exercise, massage, and relaxation can significantly reduce pain-related disability. Therefore, innovative, personalized, and easily accessible self-management solutions for cLBP are critically needed.

The present disclosure provides a method for treating a patient with VR guided acupuncture treatment. The method is based on the VRGAIT platform. The method substantially improves the 2D video-guided acupuncture imagery treatment (2D-VGAIT) through improving the vividness and immersive experience of the treatment, thereby enhancing its efficacy. The VRGAIT-based method provides a new, cost-effective, and readily accessible treatment option for cLBP, potentially extendable to other chronic pain conditions.

The VRGAIT-based method represents a groundbreaking mind-body intervention that leverages advanced VR technology, extensive medical researches of the brain mechanisms underlying acupuncture and imagery, and the past experiences developing the 2D-VGAIT platform. The VRGAIT-based method stands out from other VR-based pain management programs, which typically focus on distraction, focus shifting, skill-building, body image correction, illusion modification, or virtual graded exposure therapy.

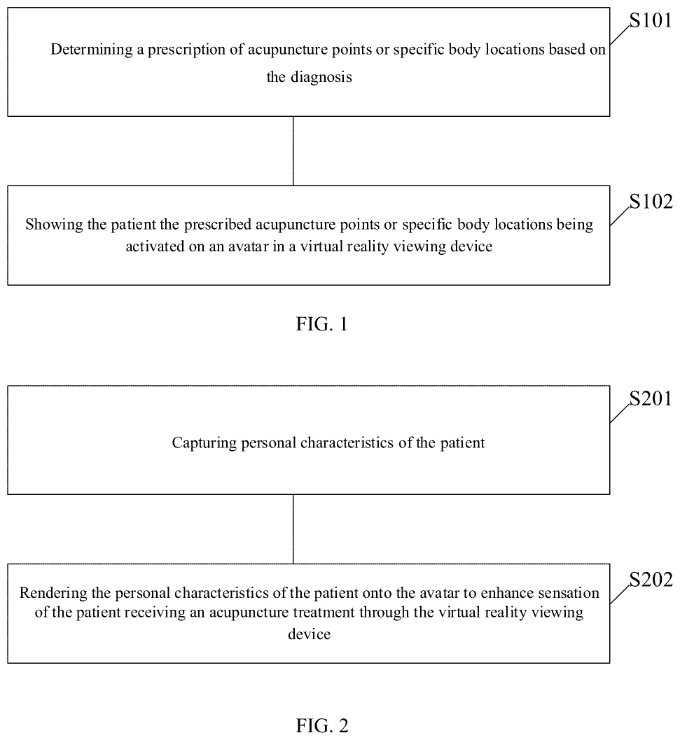

FIG. 1 is a method for treating a patient with virtual reality guided acupuncture according to some embodiments of the present disclosure. As shown in FIG. 1, the method includes following processes.

At S101, a prescription of acupuncture points or specific body locations is determined.

In some embodiments, a diagnosis of a patient is obtained. The diagnosis of the patient at least includes the chronical lower back pain. The clinical trials on the cLBP patients have shown desirable therapeutic effects. The method may also be applied to other types of patients who respond positively to traditional acupuncture treatments. These disorders include, but not limited to, other chronic pain (shoulder pain, hip pain, knee pain, headache, menstrual pain et al), stroke, mental disorders such as depression, anxiety et al.

Depending on the type of pain conditions or other disorders, different acupuncture points or specific body locations need to be stimulated on the patient. Based on the diagnosis of the patient, the prescription of acupuncture points or specific body locations may be determined. As such, a VR guided acupuncture treatment procedure is selected corresponding to the prescription of acupuncture points or specific body locations.

There are different schools of acupuncture practices. Patients may respond to one school of acupuncture practice more effective than another school of acupuncture practice. When the prescription of the acupuncture points or specific body locations is determined, information about the patient may also be considered.

At S102, the patient is shown the prescribed acupuncture points or specific body locations being activated on an avatar in a virtual reality viewing device, such that the patient receives a therapeutic effect equivalent to the patient being treated by an acupuncturist.

FIG. 2 is a flowchart of a process of obtaining content for treating a patient with virtual reality guided acupuncture according to some embodiments of the present disclosure. In some embodiments, as shown in FIG. 2, to enhance sensation of the patient receiving an acupuncture treatment through the virtual reality viewing device, the personal characteristics of the patient may be captured, and the personal characteristics of the patient may be rendered onto the avatar. When the patient sees his/her own body as the avatar, the patient tends to self-correlate with the avatar. In the cases when the personal characteristics cannot be obtained, a generic avatar or an avatar of others (such as models) may also be applied.

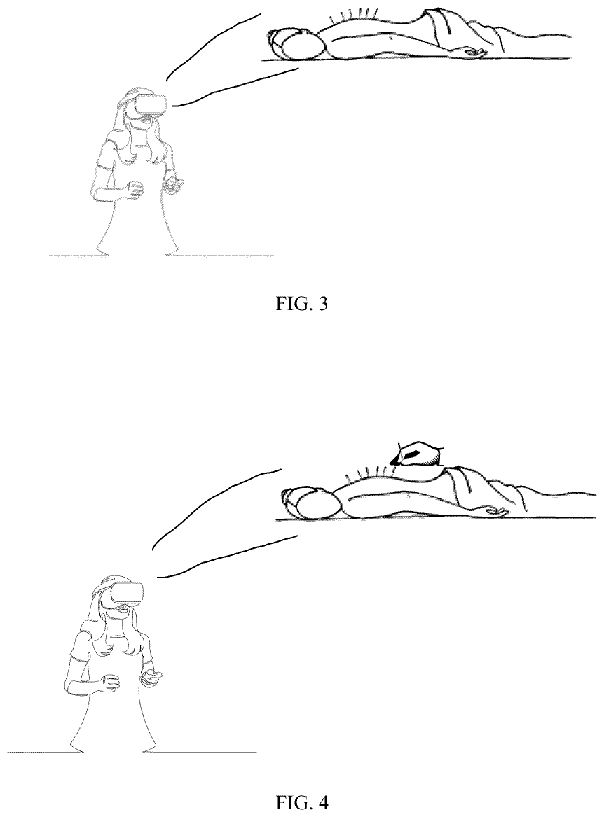

FIG. 3 is a schematic diagram showing a patient watching treatment content through a VR headset according to some embodiments of the present disclosure. As shown in FIG. 3, the patient views a VR of himself or herself being treated. The acupuncture treatment is performed on the avatar that resembles the patient to create the illusion of the acupuncture treatment being performed on the patient self.

FIG. 4 is a schematic diagram showing a patient's hand interacting with a virtual needle according to some embodiments of the present disclosure. In some embodiments, as shown in FIG. 4, when showing the patient, the prescribed acupuncture points or specific body locations being activated on the avatar in the virtual reality viewing device, the patient is guided to apply and manipulate acupuncture needles at the prescribed acupuncture points or specific body locations by accommodating physical movements of patient's hands and fingers into the acupuncture treatment being shown in the virtual reality viewing device.

In some embodiments, a patient may place actuators, such as small electrodes, on the prescribed acupuncture points or specific body locations to further stimulation. The VR device may in turn show that the acupuncture points or specific body locations are receiving more stimulation, such as the acupuncture needles going deeper, or the acupuncture needles vibrating more in the VR presented to the patient.

In some embodiments, in an initial treatment session, videos of the prescribed acupuncture points or specific body locations being activated on the patient by the acupuncturist may be captured. Virtual reality content showing the prescribed acupuncture points or specific body locations being activated on the patient is created. In subsequent treatment sessions, the patient is shown that the acupuncture treatment is performed on the avatar at the prescribed acupuncture points or specific body locations in the virtual reality viewing device.

In some embodiments, when accommodating the physical movements of the actuators into the acupuncture treatment being shown in the virtual reality viewing device, the physical movements of the actuators are captured, and the physical movements of the actuators are projected onto the avatar in the acupuncture treatment. In this case, the patient participates in the making of the VR guided acupuncture treatment.

In some embodiments, the method further includes setting up a plurality of actuators at the prescribed acupuncture points or specific body locations. In this case, the plurality of actuators may be attached to the patient's body under the guidance of an acupuncturist. However, the patient is able to manipulate the plurality of actuators through the view of the VR viewing device, thereby enhancing the effectiveness of the treatment.

In some embodiments, the method further includes recording the movements of the plurality of actuators performing the acupuncture treatment in a sample treatment session, and replaying the movements of the plurality of actuators performing the acupuncture treatment in subsequent treatment sessions. In this case, the patient actually participates in the making of the VR guided acupuncture treatment, thereby making the subsequent treatment sessions more effective.

In the embodiments of the present disclosure, the method for treating a patient with VR guided acupuncture engages the patient in the making of the VR guided acupuncture treatment content. When the VR guided acupuncture treatment is shown to the patient, the brain of the patient behaves substantially the same as actual acupuncture treatment sessions by an acupuncturist. Thus, the VR guided acupuncture treatment can be as effective as the same treatment delivered by the actual acupuncturist.

In some embodiments of the present disclosure, the VR device may provide an interface for the patient to interact with the acupuncture needles displayed. For example, the VR device may be coupled with a console that is similar to a computer game console. The console may be programmed to provide the patient with controls to move the acupuncture needles, adjust pressure on the acupuncture needles, remove acupuncture needles, or place acupuncture needles on the avatar. The console may also be programmed to provide the patient with controls over lighting, background, and other ambience settings in the VR environment. Multiple sessions of acupuncture treatments may be retrieved by using the console. For example, the patient may activate a treatment for back pain, and later activate a treatment form should pain, etc.

The present disclosure also provides a system for treating a patient with virtual reality guided acupuncture.

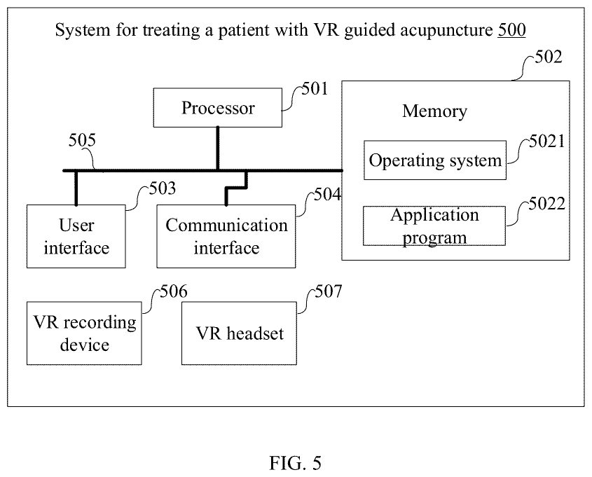

FIG. 5 is a structural diagram of a system for treating a patient with virtual reality guided acupuncture according to some embodiments of the present disclosure. As shown in FIG. 5, the system 500 includes a processor 501, a memory 502, a user interface 503, and a communication interface 504. The processor 501 may include any appropriate hardware processor or processors. The memory 502 may include any appropriate memory modules, such as ROM, RAM, flash memory modules, and erasable and rewritable memory, and mass storages, such as CD-ROM, DVD, U-disk, and hard disk, etc. The memory 502 stores an operating system 5021 and an application program 5022. When being executed by the processor 501, the application program 5022 performs the processes of the method for treating the patient with VR guided acupuncture. The user interface 503 may be used to enter the patient information and display the information about the treatment sessions. For example, the user interface 503 may be a touch screen display. The processor 501, the memory 502, the user interface 503, and the communication interface 504 are connected together through a bus 505.

The system 500 further includes a VR recording device 506. The VR recording device 506 is used to record an acupuncture treatment procedure an acupuncturist performs on a patient. The recorded acupuncture treatment procedure will be transferred from the VR recording device 506 to the memory 502 through the communication interface 504. The communication between the VR recording device and the communication interface 504 may be wired communication or wireless communication.

The system 500 further includes a VR headset 507. The VR headset is used to deliver the treatment procedure of the VR guided acupuncture to the patient. The patient watches the treatment procedure through the VR headset and receives the therapeutic effects similar to the acupuncture treatments by acupuncturists.

In some embodiments, the processor 501 is configured to determine a prescription of acupuncture points or specific body locations; and show the patient the prescribed acupuncture points or specific body locations being activated on an avatar in a virtual reality viewing device, such that the patient receives a therapeutic effect equivalent to the patient being treated by an acupuncturist.

In some embodiments, the processor 501 is further configured to: capture personal characteristics of the patient; and render the personal characteristics of the patient onto the avatar to enhance sensation of the patient receiving an acupuncture treatment through the virtual reality viewing device.

In some embodiments, when showing the patient the prescribed acupuncture points or specific body locations being activated on the avatar in the virtual reality viewing device, the processor 501 is further configured to: guide the patient to apply actuators at the prescribed acupuncture points or specific body locations by accommodating physical movements of the actuators into the acupuncture treatment being shown in the virtual reality viewing device.

In some embodiments, when showing the patient the prescribed acupuncture points or specific body locations being activated on the avatar in the virtual reality viewing device, the processor 501 is further configured to: capture videos of the prescribed acupuncture points or specific body locations being activated on the patient by the acupuncturist in an initial treatment session; create virtual reality content showing the prescribed acupuncture points or specific body locations being activated on the patient by a virtual acupuncturist; and show the patient that the virtual acupuncturist performing the acupuncture treatment on the avatar at the prescribed acupuncture points or specific body locations in the virtual reality viewing device in subsequent treatment sessions.

In some embodiments, when accommodating the physical movements of patient's hands and fingers into the acupuncture treatment being shown in the virtual reality viewing device, the processor 501 is further configured to: capture the physical movements of the patient's hands and fingers; and project the physical movements of the patient's hands and fingers onto movements of the virtual acupuncturist performing the acupuncture treatment.

In some embodiments, the processor 501 is further configured to: set up a plurality of actuators at the prescribed acupuncture points or specific body locations.

In some embodiments, the processor 501 is further configured to: record the movements of the plurality of actuators performing the acupuncture treatment in a sample treatment session; and replay the movements of the plurality of actuators performing the acupuncture treatment in subsequent treatment sessions.

In the embodiments of the present disclosure, the method for treating a patient with VR guided acupuncture engages the patient in the making of the VR guided acupuncture treatment content. When the VR guided acupuncture treatment is shown to the patient, the brain of the patient behaves substantially the same as actual acupuncture treatment sessions by an acupuncturist. Thus, the VR guided acupuncture treatment can be as effective as the same treatment delivered by the actual acupuncturist.

In the embodiments of the present disclosure, the disclosed system and method may be implemented in other ways. The system embodiment described above are intended to be illustrative. For example, division of units is merely a logical function division. In actual implementation, there may be other division methods. For example, multiple units or components may be combined, or may be integrated into another system, or some features may be ignored, or not implemented. In addition, coupling, direct coupling, or communication connection between the components shown or discussed may be through some interfaces, and the indirect coupling or connection of the devices or units may be in the form of electrical, mechanical, or other connections.

The units described above as separate components may or may not be physically separated. The components shown as units may or may not be physical units, that is, they may be located in one place or distributed to multiple network units. Some or all of the units may be selected according to actual needs to achieve the objectives of the solutions provided by the embodiments.

The methods disclosed in the method embodiments provided in the present disclosure may be combined arbitrarily to obtain new method embodiments without conflict.

The features disclosed in the product embodiments provided in the present disclosure may be combined arbitrarily without conflict to obtain new product embodiments.

The features disclosed in the method or device embodiments provided in the present disclosure may be combined arbitrarily without conflict to obtain new method embodiments or device embodiments.

The above are merely some embodiments of the present disclosure, but the protection scope of the present disclosure is not limited thereto. Any person familiar with the technical field can easily think of changes or substitutions within the technical scope disclosed in the present disclosure. Such changes or substitutions should be covered by the scope of the present disclosure. Therefore, the scope of the present disclosure should be subject to the scope of the appended claims.

What is claimed is:

1. A method for treating a patient with a virtual reality (VR) guided acupuncture, comprising:
determining a prescription of acupuncture points or specific body locations; and
showing the patient the prescribed acupuncture points or specific body locations being activated on an avatar in a virtual reality viewing device.

2. The method according to claim 1, further comprising:
capturing personal characteristics of the patient; and
rendering the personal characteristics of the patient onto the avatar to enhance sensation of the patient receiving an acupuncture treatment through the virtual reality viewing device.

3. The method according to claim 1, wherein showing the patient the prescribed acupuncture points or specific body locations being activated on the avatar in the virtual reality viewing device comprises:
guiding the patient to apply actuators at the prescribed acupuncture points or specific body locations by accommodating physical movements of actuators into the acupuncture treatment being shown in the virtual reality viewing device.

4. The method according to claim 3, wherein showing the patient the prescribed acupuncture points or specific body locations being activated on the avatar in the virtual reality viewing device further comprises:
capturing videos of the prescribed acupuncture points or specific body locations being activated on the patient in an initial treatment session;
creating virtual reality content showing the prescribed acupuncture points or specific body locations being activated on the patient; and
showing the patient the acupuncture treatment being performed on the avatar at the prescribed acupuncture points or specific body locations in the virtual reality viewing device in a treatment session.

5. The method according to claim 4, wherein accommodating the physical movements of actuators into the acupuncture treatment being shown in the virtual reality viewing device comprises:
capturing the physical movements of the actuators; and
projecting the physical movements of the actuators into the acupuncture treatment being shown in the virtual reality viewing device.

6. The method according to claim 5, further comprising:
setting up the actuators at the prescribed acupuncture points or specific body locations on the patient.

7. The method according to claim 6, further comprising:
recording the movements of the actuators performing the acupuncture treatment in a sample treatment session; and
replaying the movements of the actuators performing the acupuncture treatment in subsequent treatment sessions.

8. A system for treating a patient with a virtual reality (VR) guided acupuncture, comprising:
a processor;
a memory storing an application program;
a user interface;
a communication interface;
a VR recording device; and
a VR headset;
wherein when being executed by the processor, the application program causes the processor to:
determine a prescription of acupuncture points or specific body locations; and
show the patient the prescribed acupuncture points or specific body locations being activated on an avatar in the VR headset.

9. The system according to claim 8, wherein:
the VR recording device is configured to capture personal characteristics of the patient; and
the processor is configured to render the personal characteristics of the patient onto the avatar to enhance sensation of the patient receiving an acupuncture treatment through the virtual reality viewing device.

10. The system according to claim 8, wherein:
the processor is further configured to guide the patient to apply actuators at the prescribed acupuncture points or specific body locations by accommodating physical movements of actuators into the acupuncture treatment being shown in the virtual reality viewing device.

11. The system according to claim 10, wherein:
the VR recording device is further configured to capture videos of the prescribed acupuncture points or specific body locations being activated on the patient in an initial treatment session;
the processor is further configured to create virtual reality content showing the prescribed acupuncture points or specific body locations being activated on the patient; and
the VR headset is further configured to show the patient the acupuncture treatment being performed on the avatar at the prescribed acupuncture points or specific body locations in the virtual reality viewing device in a treatment session.

12. The system according to claim 11, wherein:
the VR recording device is further configured to capture the physical movements of the actuators; and
the processor is further configured to project the physical movements of the actuators into the acupuncture treatment being shown in the virtual reality viewing device.

13. The system according to claim 12, wherein
the actuators are set up at the prescribed acupuncture points or specific body locations on the patient.

14. The system according to claim 13, wherein:
the VR recording device is further configured to record the movements of the actuators performing the acupuncture treatment in a sample treatment session; and
the VR headset is further configured to replay the movements of the actuators performing the acupuncture treatment in subsequent treatment sessions.

15. A system for treating a patient with a virtual reality (VR) guided acupuncture, comprising:
a processor;
a memory storing an application program;
a user interface;
a communication interface;
a VR recording device;
a VR headset; and
a plurality of actuators capable of being attached to the patient and controlled by the application program to simulate acupuncture needles;
wherein when being executed by the processor, the application program causes the processor to:
determine a prescription of acupuncture points or specific body locations; and
show the patient the prescribed acupuncture points or specific body locations being activated on an avatar in the VR headset.

16. The system according to claim 15, wherein:
the VR recording device is further configured to capture videos of the prescribed acupuncture points or specific body locations being activated on the patient in an initial treatment session;
the processor is further configured to create virtual reality content showing the prescribed acupuncture points or specific body locations being activated on the patient; and
the VR headset is further configured to show the patient the acupuncture treatment being performed on the avatar at the prescribed acupuncture points or specific body locations in the virtual reality viewing device in a treatment session.

17. The system according to claim 15, wherein:
after the plurality of actuators are attached to the prescribed acupuncture points or specific body locations on the patient, the processor is further configured to guide the patient to control the plurality of actuators attached to the prescribed acupuncture points or specific body locations to perform the acupuncture treatment being shown in the virtual reality viewing device.

18. The system according to claim 17, wherein:
the patient is guided to control the plurality of actuators attached to the prescribed acupuncture points or specific body locations through a virtual control console shown in the virtual reality viewing device.

19. The system according to claim 18, wherein:
the VR recording device is further configured to capture physical movements of the plurality of actuators; and
the processor is further configured to project the physical movements of the plurality of actuators into the acupuncture treatment being shown in the virtual reality viewing device.

20. The system according to claim 19, wherein:
the VR recording device is further configured to record the movements of the plurality of actuators performing the acupuncture treatment in a sample treatment session; and
the VR headset is further configured to replay the movements of the plurality of actuators performing the acupuncture treatment in subsequent treatment sessions.
